(19) United States
(12) Patent Application Publication
(10) Pub. No.: US 2007/0218447 A1
(43) Pub. Date: Sep. 20, 2007

(54) Recommended improvement plan integration in an online environment method and system

(75) Inventor: Shishir Madhav Chavan, Cupertino, CA (US)

Correspondence Address: Raj Abhyanker, LLP;c/o PortfolioIP, P.O. Box 52050, Minneapolis, MN, 55402, US

(73) Assignee: Weavex

(21) Appl. No.: 11/376,425

(22) Filed: Mar. 15, 2006

(51) Int. Cl. G09B 3/00

(52) U.S. Cl. 434/350

(57) ABSTRACT

Recommended improvement plan integration in an online environment method and system is disclosed. In one embodiment, a method includes allocating an improvement plan to a user context based on a descriptive information of the user context, integrating a history data of an item (e.g., in the improvement plan) to the improvement plan, and simultaneously displaying the history data of the item (e.g, in the improvement plan) and the improvement plan the user based on the data maintained in the access module. The access module may be shared in a consortium of individual member organizations. The history data may correspond to a previous association between the user and the item, and the previous association may be based on a check-out data, a purchase data, a hold data, a quiz data, and/or a manual submission data.

### FIELD OF TECHNOLOGY

This disclosure relates generally to the technical fields of software, database, and/or hardware technology and, in one example embodiment, to a method and/or a system of recommended improvement plan integration in an online environment.

### BACKGROUND

An improvement plan (e.g., a reading list) may be recommended by an agency (e.g., a government agency such as a State Department of Education) to a guardian (e.g., a parent) and/or a student (e.g., a grade school child) based on the student's performance in a standardized test (e.g., a State Achievement Test). The guardian and/or the student may choose to purchase through an e-commerce website (e.g., Amazon.com®, Barnes & Noble®, etc.) or through an online content provider items (e.g., books) and/or to borrow (e.g., through a local public library) items identified in the improvement plan to improve/increase the student's ability and/or score in the standardized test a following year (e.g., the standardized test in the following year may be more difficult based on the student's age and/or grade level).

When the guardian and/or the student is interested in purchasing and/or borrowing items in the improvement plan, the guardian and/or the student may physically print out the improvement plan, and may manually enter specific items (e.g., books) in a computerized system (e.g., an Internet based website and/or a terminal at a library) to check for availability of the specific items. The guardian and/or the student may have to rely on their own mental recollection to determine whether some items in the improvement plan were previously accessed (e.g., checked out, read, purchased, etc.).

The guardian and/or the student may perform a number of time-consuming and inconvenient tasks such as manually copying/typing/printing items of the improvement plan, entering each item separately in the computerized system, checking availability one at a time etc. These tasks may be burdensome and may cause the guardian and/or the student to lose interest in the improvement plan and/or to postpone diligent adherence to the improvement plan. As a result, the student's ability may not show improvement and the desired objective or improved score on the standardized test may not be achieved.

### SUMMARY

Recommended improvement plan integration in an online environment method and system is disclosed. In one aspect, a method includes allocating an improvement plan (e.g., a recommended list of books and/or educational videos to read/view) to a user context based on a descriptive information of the user context, integrating a history data of an item in the improvement plan to the improvement plan, and simultaneously displaying the history data of the item in the improvement plan and the improvement plan to the user based on the data maintained in the access module. The descriptive information of the user context may be provided by the user, and may include an age data, a grade data, a performance data, a calendar data, and/or an aptitude data. The history data may correspond to a previous association between the user and the item, and the previous association may be based on a check-out data, a purchase data, a hold data, a quiz data, and/or a manual submission data.

The improvement plan may be generated based on a performance of the user on a standardized test (e.g., a State Achievement Test). The improvement plan may be printed on a report card of the user's performance on the standardized test. The improvement plan may be recommended by a government agency (e.g., a State Department of Education) to the user, and the standardized test may determine which items are displayed in the improvement plan. The standardized test may be administered annually, and the improvement plan may include between thirty and one hundred twenty individual items.

The improvement plan may be periodically updated through a Really Simple Syndication (RSS) feed from the government agency, and the history data may be updated based on a success flag associated with a quiz data in the access module. The integration server may automatically apply an availability data of at least one library to the improvement plan (e.g., a recommended reading list) by associating the availability data with at least some items of the improvement plan (e.g., recommended reading list). The access module may be shared in a consortium of individual member organizations (e.g., libraries). The history data of the item and an availability data (e.g., including a physical shelf location at an access site) of the item may be displayed using a dashboard view that may render a previously accessed status indicator, a never accessed status indicator, and/or a percentage-accessed indicator.

In another aspect, a system includes a student module to allocate an improvement plan to a user context based a descriptive information of the user context; and a guardian module associated with the student module to administer a quiz data of the improvement plan to students associated with a guardian. The student module may simultaneously display a history data of an item in the improvement plan to the students and the guardian based on a data maintained in an access module. The history data may correspond to a previous association between the student and the item based on a check-out data, a purchase data, a hold data, a quiz data, and a manual submission data.

A government reporting module may analyze the quiz data of the students with other quiz data associated with different users to annually optimize the improvement plan. The guardian module may recommend online tutoring services for the students based on a performance threshold in the quiz data.

In a further aspect, a network includes a testing server to generate a recommended reading data based on a performance by a student in a standardized test, and an integration server to automatically merge the recommended reading data with a library access data associated with the student. The recommended reading data may be periodically updated through a Really Simple Syndication (RSS) feed from a government agency.

The methods, systems, and apparatuses disclosed herein may be implemented in any means for achieving various aspects, and may be executed in a form of a machine-readable medium a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a block diagram of an integration module communicating with a history network and a testing server through a network, according to one embodiment.

FIG. 2 is an exploded view of the integration module of FIG. 1, according to one embodiment.

FIG. 3 is a graphical user interface of the student module of FIG. 2, according to one embodiment.

FIG. 4 is a graphical user interface of the guardian module of FIG. 2, according to one embodiment.

FIG. 5 is a table view of a list database of the integration module of FIG. 2, according to one embodiment.

FIG. 6 is a diagrammatic representation of a data processing system capable of processing a set of instructions to perform any one or more of the methodologies herein, according to one embodiment.

FIG. 7 is a data interaction diagram between the guardian module and the student module of FIG. 2, according to one embodiment.

FIG. 8 is a process flow to allocate an improvement plan to a user context based on a descriptive information of the user context, according to one embodiment.

Other features of the present embodiments will be apparent from the accompanying drawings and from the detailed description that follows.

### DETAILED DESCRIPTION

Recommended improvement plan integration in an online environment method and system is disclosed. In the following description, for the purposes of explanation, numerous specific details are set forth in order to provide a thorough understanding of the various embodiments. It will be evident, however to one skilled in the art that the various embodiments may be practiced without these specific details.

An example embodiment provides a method that includes allocating an improvement plan to a user context based on a descriptive information of the user context, integrating a history data of an item in the improvement plan to the improvement plan, and simultaneously displaying the history data of the item in the improvement plan and the improvement plan to the user based on the data maintained in the access module. It will be appreciated that the various embodiments discussed herein may/may not be the same embodiment, and may be grouped into various other embodiments not explicitly disclosed herein.

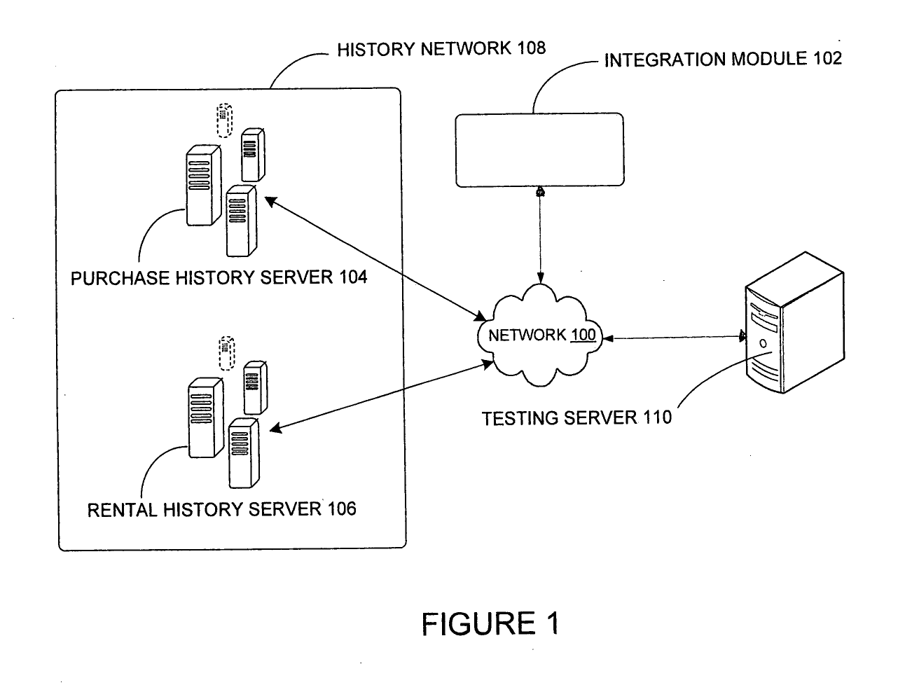

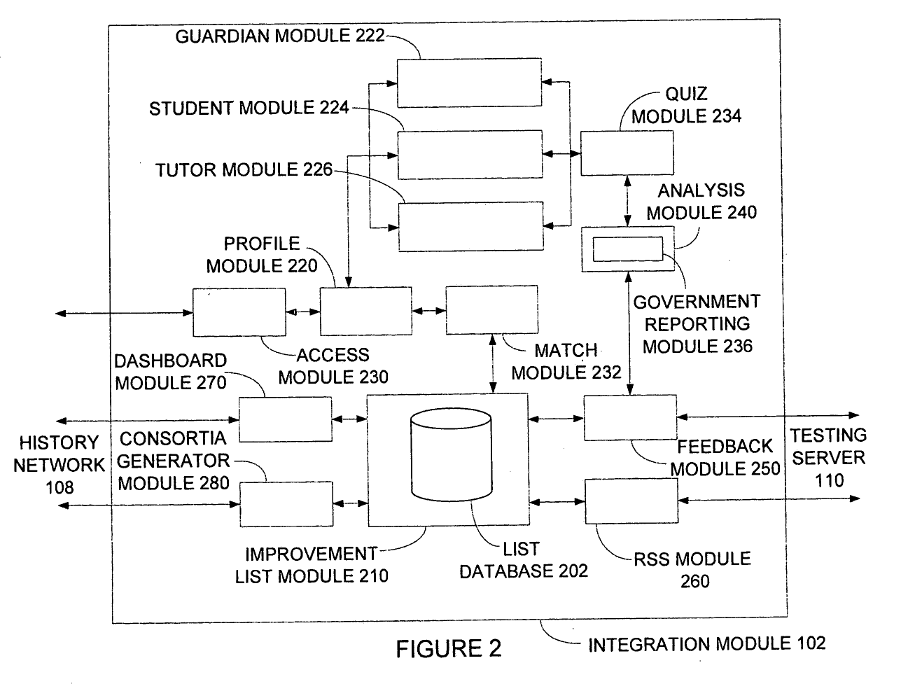

FIG. 1 is a block diagram of an integration module 102 communicating with a testing server 110 and a history network 108 of purchase history servers 104 and rental history server 106 through a network 100, according to one embodiment. The history network 108 may include one or more purchase history servers 104 and rental history server 106. The integration module 102 may automatically merge and integrate data from the testing server 110 with the purchase history servers 104 and the rental history server 106 of the history network 108 (e.g., as illustrated in detail with reference to FIG. 2). In FIG. 1, the integration module is shown to be distinct from the testing server 110, and the history network 108, and communicating with the testing server 110, and the history network 108 through the network 100, however, modules of the integration module 102 (e.g., the student module 224, the access module 230, the analysis module 240 etc as shown in FIG. 2) may be integrated within the purchase history servers 104, the rental history server 106, and/or the testing server 110, according to various embodiments.

The testing server 110 (e.g., that hosts a website of a government agency such as a state department of education) may provide a link to a standardized testing program, and may generate an improvement plan (e.g., a researched list having a recommended course of action) based on a performance of a user on a standardized test of the program. The improvement plan may also be based on a grade level of the user. In one embodiment, the improvement plan may be created by any individual and/or organization (e.g., a government agency, a librarian, a student, a guardian, etc.) based on a criteria associated with a student (e.g., a performance of the student). In this one embodiment, the improvement plan may leverage preexisting data (e.g., bookseller lists, price winning items such as videos and or literary materials, etc.). The standardized test may be administered annually. A link to the improvement plan on the testing server 110, and history data (e.g., obtained from rental history server 106) may be printed on a user report card. In addition, history servers that integrate the improvement plan, and details on the same may be mentioned on the report card.

The improvement plan may include a list of items (e.g. books, testing material and/or educational videos) that may help the user (e.g., a student) improve a score on the standardized test. The improvement plan may include between thirty and one hundred twenty individual items. The testing server 110 may periodically update the improvement plan and communicate updates to the integration module 102 through a Really Simple Syndication (RSS) feed (e.g., to the RSS module 260 of FIG. 2). The testing server 110 may also update the improvement plan based on feedback received from the integration module 102 (e.g., through the feedback module 250 of FIG. 2)

The testing server 110 may include information about the availability of items of the list in various history servers (e.g., the rental history server 106) over the history network 108. The testing server 110 may also estimate the number of copies of items of the improvement plan that users of the history servers may require, and send alerts to the history servers accordingly. Further, the testing server 110 may direct the user to the specific rental history server 106 of which the user is a member and/or to the purchase history server 104 that offers an item of the list at a convenient price.

The rental history server 106 (e.g., that hosts a city library website) may be populated with lists from improvement plans generated at the testing server 110 through the integration module 102. A user of the rental history server 106 may directly view the list according to the improvement plan, and also simultaneously view the history data of items of the list (e.g., whether the item has been previously checked by the user), which may be maintained in an access module (e.g., the access module 230 of FIG. 2). In one embodiment, the access module may link an improvement plan to an access record of a user (e.g., of an individual member, a student, and/or a guardian, etc.), an availability status (e.g., of a library book) and/or other information that may enable the user to monitor a progress of the improvement plan (e.g., by enabling a user to take an action through a single-view dashboard interface).

The user may also check availability details of items of the list, such as whether the item is available at the same history server, or at another history server (e.g., of the history network 108) that may be a member of a consortium (e.g., through the consortia generator module 280 of FIG. 2). The user may also view details on the location of the item (e.g., a physical location on the shelf of a library), and place items of the list on hold (e.g., as per library regulations), and/or place items in a shopping cart for purchase (e.g., from a purchase history server 104).

FIG. 2 is an exploded view of the integration module 102 of FIG. 1 having an improvement list module 210, a profile module 220, a guardian module 222, a student module 224, a tutor module 226, an access module 230, a match module 232, a quiz module 234, an analysis module 240, a feedback module 250, an RSS module 260, a dashboard module 270, and a consortia generator module 280, according to one embodiment. The improvement list module 210 may obtain data associated with improvement plans from the testing server 110 through the network 100 of FIG. 1. The improvement list module 210 may communicate with the testing server 110 through the feedback module 250, and the RSS module 260. The improvement list module 210 may communicate with the history network 108 through the dashboard module 270 and the consortia generator module 280. In addition, the improvement list module 210 may communicate with the profile module 220 through the match module 232.

FIG. 2 illustrates that the profile module 220 exchanges data with the access module 230, the guardian module 222, the student module 224, and the tutor module 226. Also, the guardian module 222, the student module 224, and the tutor module 226 interact with the quiz module 234, which further communicates with the analysis module 240. The analysis module 240 may analyze data obtained from the quiz module 234, and provide comparative analyses to the feedback module 250.

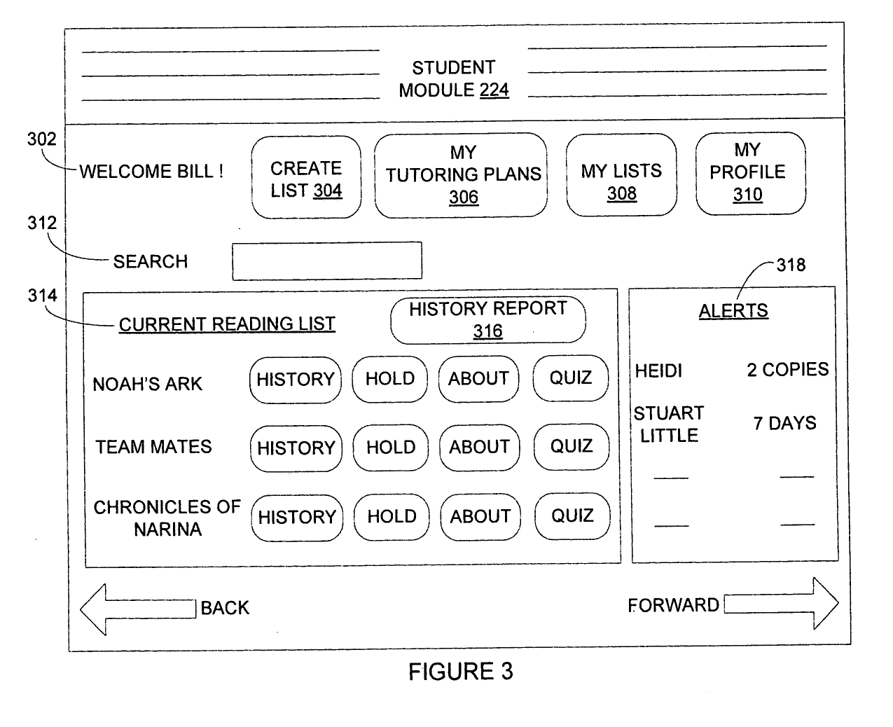

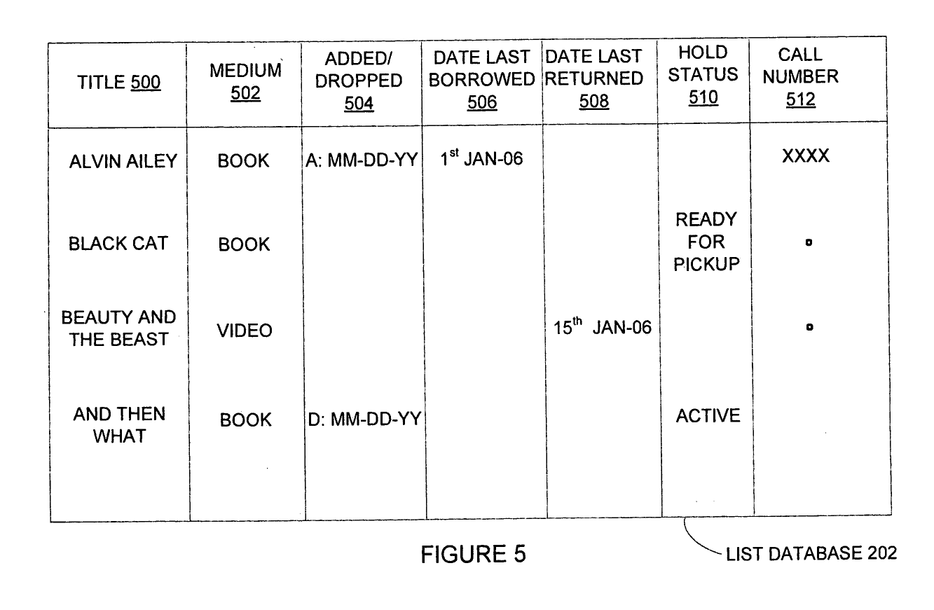

Improvement plans corresponding to various users and scores may be stored in a list database 202 of the improvement list module 210. In addition to the improvement plans, the improvement list module 210 may also process history data (e.g., a previous association between the user and the item, such as a date last borrowed, added/dropped etc as illustrated in FIG. 5) stored in the list database 202. The list database 202 may also include a list of web pages to be viewed as part of an improvement plan. The history information associated with the web pages may be updated in an access module (e.g., the access module 230 of FIG. 2) when a user (e.g., a user of the student module 224 of FIG. 3) selects a certain page as viewed. The match module 232 may match the appropriate recommended list in the improvement list module with the user based on the user profile data in the profile module 220.

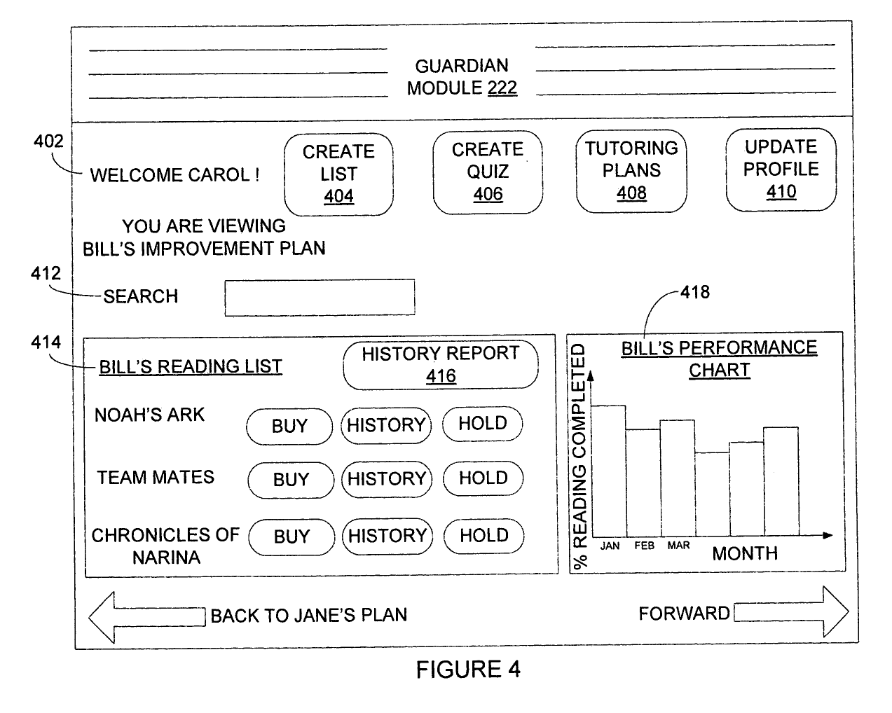

The access module 230 may provide an access privilege to a user based on a permission derived from an association formed during a registration stage, or updated by another user (e.g., a guardian may update a profile and access privileges of an associated student module 224 by clicking on an update profile trigger 410 (e.g., a button, a module, etc.) as illustrated in FIG. 4). Further, the access module 230 may interact with a history server (e.g., the rental history server 106 of FIG. 1) to maintain history data (e.g., check-out data, a purchase data, a hold data, a page view data, a quiz data, and a manual submission data) of an item associated with an improvement plan (e.g., stored in list database 202 of the improvement list module 210). The history data in the access module 230 may be updated based on a success flag associated with a quiz data obtained from the quiz module 234.

The profile module 220 may maintain and store data associated with a user context such as descriptive information (e.g., user type, age data, grade data, a performance data, calendar data, aptitude data). This data may be exchanged with the access module 230 and the match module to provide access privileges and to match the profile with the appropriate improvement plan (e.g., chosen from the improvement list module 210) respectively. The profile module 220 may map the access privileges to the guardian module 222, the student module 224, and/or the tutor module 226.

The guardian module 222 may create a quiz and/or select an existing quiz from the quiz module 234 to be administered to a student associated with a guardian. The guardian module may display a history information of the student (e.g., obtained from the access module 230) and analysis information (e.g., a performance chart as 418 as illustrated in FIG. 4) obtained from the analysis module 240. The guardian module may also update profiles data and/or access privileges of users through the profile module 220 and/or the access module 230.

The student module 224 may process a user profile and descriptive information of the user context, and based on the descriptive information, display the appropriate improvement plan. The student module 224 may simultaneously display a history data of an item in the improvement plan, either in the list itself adjacent to the item title, or on a history report of all items of a list (e.g., as illustrated in FIG. 3). The student module 224 may also provide the option of taking a quiz (e.g., administered by the guardian module 222 and/or the tutor module 226). The student module 224 may display tutoring plans for the user (e.g., recommended by the guardian module 222 and/or the tutor module 226), and alerts for availability information associated with items and/or targets related to the improvement plan (e.g., set by the guardian module 222 and/or the tutor module 226).

The quiz module 234 may be populated with quizzes from the guardian module 222 and/or the tutor module 226 associated with each item of the list in the improvement list module. The tutor module 226 may be integrated with an online learning resource to provide additional improvement plans targeted at improvement specific areas, as recommended by the guardian module 222 based on a performance threshold in the quiz data. The analysis module 240 may compile the quiz data and provide various analyses to monitor the progress of a student.

In addition, the analysis module 240 is illustrated as including a government reporting module 236 to analyze the quiz data of the student with other quiz data associated with different users statistically, and perform comparative analyses of quiz scores and grades with progress in reading. These analyses may be communicated to the feedback module 250, which may provide feedback based on the analyses to the testing server 110. The feedback may include suggesting changes to the improvement plan (e.g, upgrading the recommended lists for a particular grade/level).

The RSS module 260 may periodically update the improvement list module 210 through a Really Simple Syndication (RSS) feed from the government agency (e.g., the testing server 110). The RSS feed may include summaries of changes to the lists together with links to the full versions of the new lists, and other meta-data. In addition to facilitating syndication, the RSS module may allow tracking of updates using an aggregator. The dashboard module 270 may render history data of an item of a list (e.g., from the list database 202 of the improvement list module 210) and an availability data of the item in a dashboard view comprising a previously accessed status indicator, a never accessed status indicator, and a percentage accessed indicator, physical location on shelf.

The dashboard module may be integrated with the guardian module 222 and/or the student module 224. The consortia generator module 280 may communicate with history servers on the history network 108 and provide availability data from other history servers associated with a consortium. The consortia generator module 280 may facilitate the tracking of history data of a user across various history servers including the purchase history server 104 and rental history server 106. The access module 230 may shared in the history servers, to maintain the history data and enable tracking across the servers.

FIG. 3 is a graphical user interface of the student module 224 of FIG. 2, according to one embodiment. The graphical user interface includes a welcome view 302, a create list trigger 304, a tutoring plans trigger 306, a lists trigger 308, a profile trigger 310, a search box 312, a current reading list view 314, a history report trigger 316, and an alerts view 318. The welcome view 302 may display the name of the user on login (e.g., Welcome Bill). A new list may be created using the create list trigger 304, that may open an input page where the user enters information on items of the new list.

Alternatively, the user may select items from existing lists by ticking a button adjacent to list items, and use the create list trigger 304 to export the selected items into the new list. Lists may be classified according to various categories and the user may select a most suitable list from the appropriate category through a drop down, and edit items of the list to create a new list. The tutoring plans trigger 306 may be used to view tutoring plans for the user. The tutoring plans may be created by the user, or updated by a guardian module 222 (e.g., using the tutoring plans trigger 406 as shown in FIG. 4) and/or a tutor module 226. Tutoring plans for a user may be viewed, and progress in each plan may be tracked using the tutoring plans trigger 306. The lists trigger 308 may be used to view all the lists for a user (e.g., created by the user, a guardian, a rental server staff, a list administrator and/or a tutor) and display history information of each. The profile trigger 310 may be used to enter and update descriptive information associated with a user context (e.g., age data, a grade data, a performance data, a calendar data, and an aptitude data).

The search box 312 may be used to search for specific items and/or lists by entering keywords, class, medium, call number and/or any of the searchable fields of the database (e.g., the fields of the list database 202 as shown in FIG. 5). The items displayed from the search result may also indicate the one or more lists that they belong to, with a link to provide history data of each displayed item. The search query may also be related to history data (e.g., a search for all items borrowed before a particular date, items of a list that have not yet been added, etc).

The current reading list view 314 may display the list that the user has selected as current (e.g., a list from the lists trigger 308 may be selected as the current reading list). The information shown in the current reading list view 314 may include a title of the item (e.g., Noah's ark, Team Mates, Chronicles of Narnia as shown in FIG. 3), a history trigger to display a complete history data for the item (e.g., including a hold data and/or an access data), a hold trigger to place a hold request on the item (e.g., from a rental history server 106 of FIG. 1 where the item is available and/or of which the user is a member), an about trigger to display other information related to the item (e.g., author, a description of contents etc), and a quiz trigger that may enable the user to take a quiz on the item. The results of the quiz may be sent to a quiz module (e.g., the quiz module 234 of FIG. 2), and the history data in an access module (e.g., the access module 230 of FIG. 2) may be updated based on a success flag associated with the quiz data.

The hold trigger may enable the user to first display the availability status of the item (e.g., a home call number, a call number from a different rental server in a consortium, a home due date, a due date from a different rental server in a consortium of rental servers etc), and then place the item on hold at the appropriate location in an integrated manner. The history report trigger 316 may be used to display a complete history report of all items of the current reading list. The report may be a dashboard with titles such as items previously accessed, never accessed, percentage of items accessed (e.g., obtained from the dashboard module 270). The history report may also include a complete availability information (e.g., including call number, rental server, and shelf location) alongside each item of the list, which may be printed by a user, thereby simplifying and integrating monitoring progress of the improvement plan. The alerts view 318 may display alerts on targets (e.g., only 7 days left for Stuart Little to be read to meet target) and/or availability data of items (e.g., only 2 copies left for Heidi) associated with the improvement plan.

FIG. 4 is a graphical user interface of the guardian module 222 of FIG. 2, according to one embodiment. The graphical user interface includes a welcome view 402, a create list trigger 404, a tutoring plans trigger 406, an list trigger 408, profile trigger 410, a search box 412, a student reading list view 414, a history report trigger 416, a student performance view 418, and a back trigger 420. The welcome view 402 may display the name of the user on login (e.g., Welcome Carol), and also display the name of the student associated with the guardian module who's plan is being viewed (e.g., the student Bill's improvement plan).

A new list for a student may be created using the create list trigger 404, that may open an input page where the user (e.g., the guardian Carol) enters information on items of the new list. Alternatively, the user may select items from existing lists by ticking a button adjacent to list items, and use the create list trigger 404 to export the selected items into the new list. The created list may be populated in a list database (e.g., the list database 202 of FIG. 2) and may be made accessible to the student through a lists trigger (e.g., the lists trigger 308 in the student module 224 of FIG. 3). The tutoring plans trigger 406 may be used to view tutoring plans for the student (e.g., Bill) and/or add a new tutoring plan (e.g., integrated with an online learning resource and/or tutoring service provider). The update profile trigger 410 may enable the user (e.g., the guardian Carol) to update the profile and/or access privileges of a student (e.g., Bill). The search box 412 may be used to search for specific items and/or lists by entering keywords, class, medium, call number and/or any of the searchable fields of the database (e.g., the fields of the list database 202 as shown in FIG. 5).

The student reading list view 414 may display details of items from an improvement plan such as title of the item (e.g., Noah's ark, Team Mates, Chronicles of Narnia as shown in FIG. 4), a buy trigger that may enable the guardian to purchase the item (e.g., from a purchase history server 104 of FIG. 1), a history trigger to display a complete history data for the item (e.g., including a hold data and/or an access data), and a hold trigger to place a hold request on the item (e.g., from a rental history server 106 of FIG. 1 where the item is available and/or of which the user is a member). The hold trigger may enable the user to first display the availability status of the item (e.g., a home call number, a call number from a different rental server in a consortium, a home due date, a due date from a different rental server in a consortium of rental servers etc), and then place the item on hold at the appropriate location in an integrated manner.

The history report trigger 416 may be used to display a complete history report of all items of the current reading list. The history report may also include a complete availability information (e.g., including call number, rental server, and shelf location) alongside each item of the list, which may be printed by a user, thereby simplifying and integrating monitoring progress of the improvement plan. The student performance view 418 report may be a dashboard with titles such as items previously accessed, never accessed, percentage of items accessed (e.g., obtained from the dashboard module 270), monthly quiz scores, percentage of reading completed each month, etc. Back and forward triggers may allow the guardian to view the improvement plan of another student associated with the guardian (e.g., Jane's improvement plan).

Optionally, the student reading list view 414 may include a comments trigger (e.g., not shown in FIG. 4) that may enable a guardian to provide feedback about the item (e.g., whether it was useful, interesting etc.). The comments may be sent through a feedback module (e.g., the feedback module 250 of FIG. 2) to a testing server (e.g., the testing server 110 of FIG. 2) that may process the comments to update the plan periodically.

FIG. 5 is a table view of a list database 202 of the integration module 102 of FIG. 2, according to one embodiment. The table view includes a title field 500, a medium field 502, an added/dropped details 504, a date last borrowed 506, a date last returned 508, a hold status 510, and a call number 512. The title field 500 may contain the title of the item (e.g., Alvin Ailey, Black Cat, Beauty and the beast as shown in FIG. 5). The medium field 502 may store information on the type of medium (e.g., if the item is a book and/or video).

The added/dropped details may 504 indicate whether an item has been added or dropped, along with the corresponding date (e.g., A: mm-dd-yy may indicate that the item was added on the date mm-dd-yy). The date last borrowed 506 may include the date the item was borrowed most recently (e.g., D: mm-dd-yy may indicate that the item was dropped on the date mm-dd-yy), and the date last returned 508 may include the date that the item was borrowed most recently (e.g., 1 Jan. 2006). The hold status 510 may indicate whether item is ready for pickup, or active, and a call number 512 may be a unique identifier to retrieve the availability information (e.g., a reference to a library from a consortium, and the physical location of the item at a shelf of a library from a consortium). The table may also include various other fields (e.g., not shown in FIG. 5) that may enable a user of a student module, guardian module etc to access, display and/or print availability information of each item (e.g., a status indicator of which rental servers, an item is available, a due date of the item at a home rental server, a due date of the item at another rental server of the consortium, etc.)

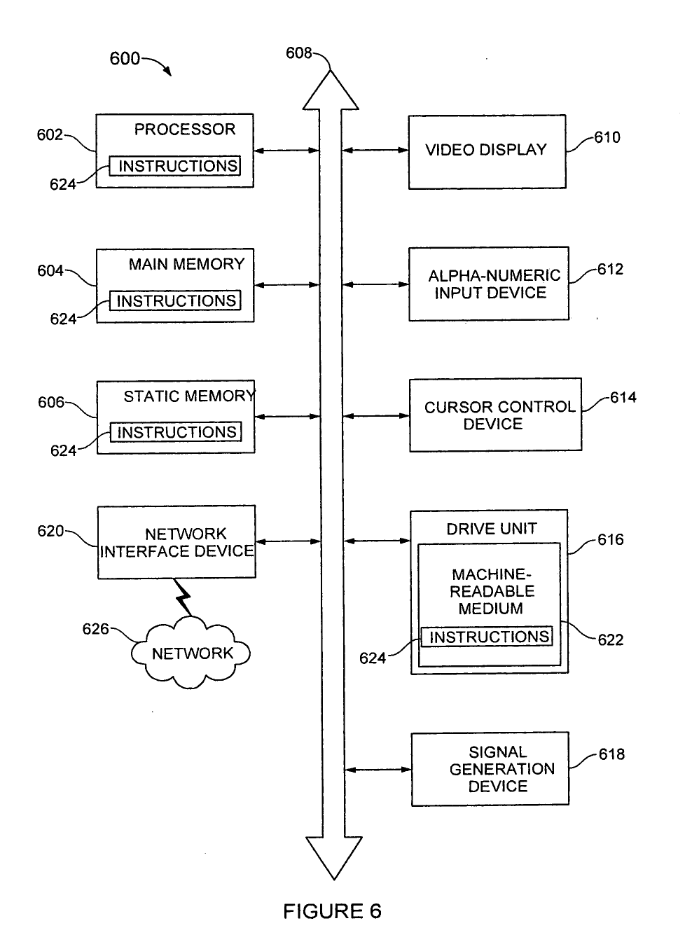

FIG. 6 is a diagrammatic representation of a data processing system capable of processing a set of instructions to perform any one or more of the methodologies herein, according to one embodiment. FIG. 6 shows a diagrammatic representation of machine in the example form of a computer system 600 within which a set of instructions, for causing the machine to perform any one or more of the methodologies discussed herein, may be executed. In various embodiments, the machine operates as a standalone device and/or may be connected (e.g., networked) to other machines.

In a networked deployment, the machine may operate in the capacity of a server and/or a client machine in server-client network environment, and/or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch and/or bridge, an embedded system and/or any machine capable of executing a set of instructions (sequential and/or otherwise) that specify actions to be taken by that machine. Further, while only a single machine is illustrated, the term “machine” shall also be taken to include any collection of machines that individually and/or jointly execute a set (or multiple sets) of instructions to perform any one and/or more of the methodologies discussed herein.

The example computer system 600 includes a processor 602 (e.g., a central processing unit (CPU) a graphics processing unit (GPU) and/or both), a main memory 604 and a static memory 606, which communicate with each other via a bus 608. The computer system 600 may further include a video display unit 610 (e.g., a liquid crystal display (LCD) and/or a cathode ray tube (CRT)). The computer system 600 also includes an alphanumeric input device 612 (e.g., a keyboard), a cursor control device 614 (e.g., a mouse), a disk drive unit 616, a signal generation device 618 (e.g., a speaker) and a network interface device 620.

The disk drive unit 616 includes a machine-readable medium 622 on which is stored one or more sets of instructions 624 (e.g., software) embodying any one or more of the methodologies and/or functions described herein. The instructions 624 may also reside, completely and/or at least partially, within the main memory 604 and/or within the processor 602 during execution thereof by the computer system 600, the main memory 604 and the processor 602 also constituting machine-readable media.

The instructions 624 may further be transmitted and/or received over a network 626 via the network interface device 620. While the machine-readable medium 622 is shown in an example embodiment to be a single medium, the term “machine-readable medium” should be taken to include a single medium and/or multiple media (e.g., a centralized and/or distributed database, and/or associated caches and servers) that store the one or more sets of instructions. The term “machine-readable medium” shall also be taken to include any medium that is capable of storing, encoding and/or carrying a set of instructions for execution by the machine and that cause the machine to perform any one or more of the methodologies of the various embodiments. The term “machine-readable medium” shall accordingly be taken to include, but not be limited to, solid-state memories, optical and magnetic media, and carrier wave signals.

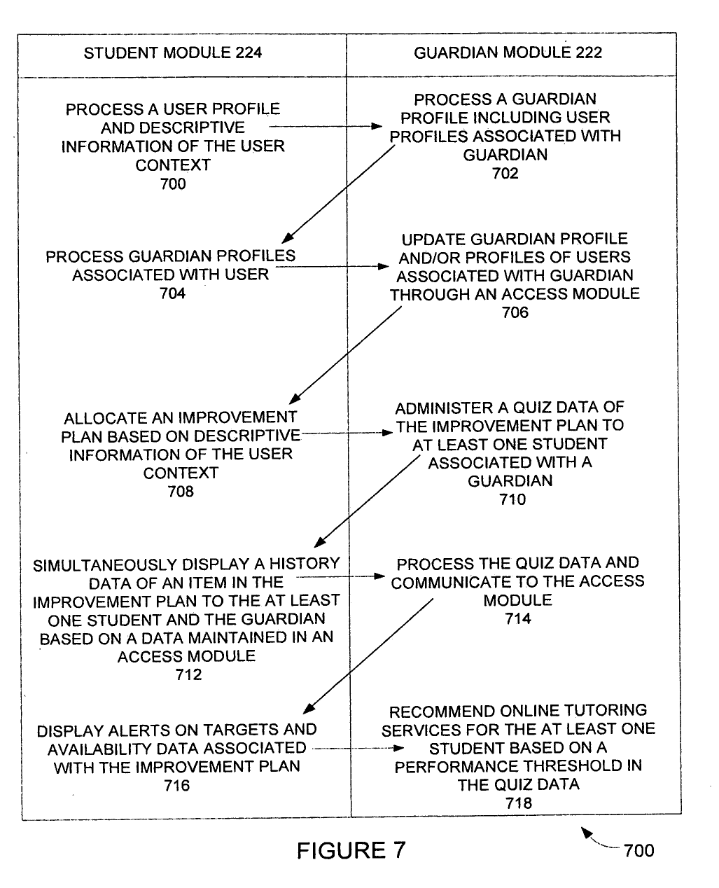

FIG. 7 is a data interaction diagram between the guardian module 222 and the student module 224 of FIG. 2, according to one embodiment. FIG. 7 illustrates a series of operations carried out during various stages of interaction between the guardian module 222 and the student module 224. At operation 700, a user profile and descriptive information of the user context (e.g., age data, a grade data, a performance data, a calendar data, and an aptitude data) is processed at the student module 224. At operation 702, a guardian profile (e.g., for a guardian Carol as shown in FIG. 4) including user profiles associated with the guardian (e.g., Bill and Jane) is processed at the guardian module 222. At operation 704, guardian profiles associated with the user are processed at the student module 224 (e.g., a user Bill may enter that he is associated with the guardians Carol and Ted at student module 224). At operation 706, the guardian profile and/or profiles of users associated with the guardian are updated through an access module (e.g., the access module 230 of FIG. 2) at the guardian module 222.

At operation 708, an improvement plan is allocated based on descriptive information of the user context at the student module 224. At operation 710, the guardian module 222 may administer a quiz data of the improvement plan to at least one student module associated with the guardian. The quiz data may be populated in the quiz module 234 of FIG. 2 and communicated to the student module 224 where it may be added to the appropriate item on which the quiz is based. At operation 712, a history data (e.g., of an item in the improvement plan is simultaneously displayed (e.g., using the history trigger on the current reading list view 314 of FIG. 3) at the student module 224 to the at least one student and the guardian based on a data maintained in an access module (e.g., the access module 230 of FIG. 2).

At operation 714, the quiz data is processed at the guardian module 222 (e.g., in conjunction with the quiz module 234 and the analysis module 240 of FIG. 2) and communicated to the access module. At operation 716, the student module 224 may display alerts on targets and availability data (e.g., only 2 copies left for Heidi as shown in FIG. 3) associated with the improvement plan. At operation 718, the guardian module 222 may recommend online tutoring services (e.g., using the tutoring plans trigger 406 as shown in FIG. 4) for the at least one student based on a performance threshold in the quiz data.

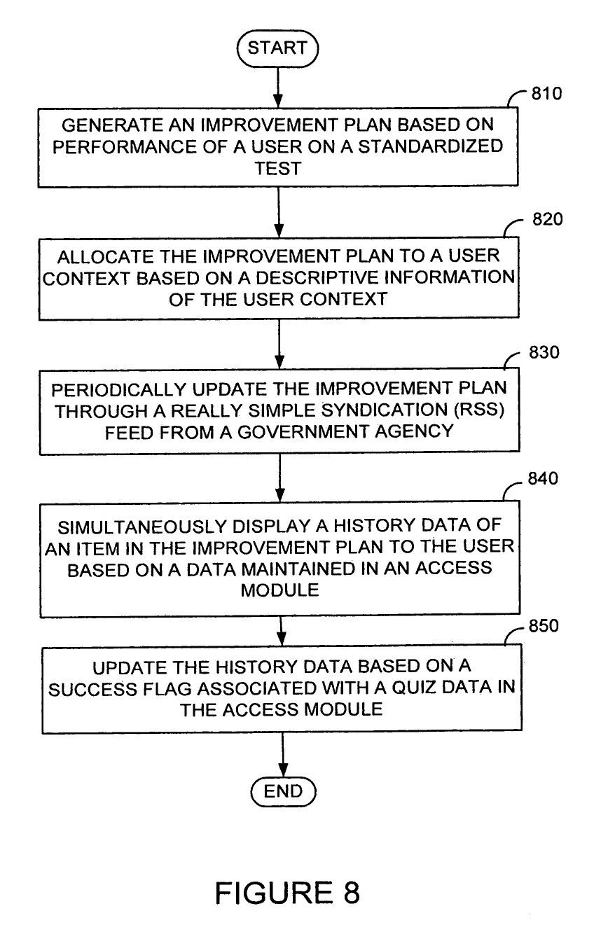

FIG. 8 is a process flow to allocate an improvement plan to a user context based on a descriptive information of a user context, according to one embodiment. At operation 810, an improvement plan is generated based on a performance of the user on a standardized test (e.g., administered annually by a government agency). At operation 820, the improvement plan is allocated to a user context based on a descriptive information (e.g., a grade data, a performance data) of the user context. At operation 830, the improvement plan is periodically updated through a Really Simple Syndication (RSS) feed (e.g., obtained by the RSS module 260 of FIG. 2) from a government agency. The RSS feed may include summaries of changes to the lists together with links to the full versions of the new lists, and other meta-data. Then, a history data of an item in the improvement plan may be integrated to the improvement plan (e.g., to provide a user friendly, efficient, and single view of the history data and the improvement plan).

At operation 840, a history data of an item in the improvement plan is simultaneously displayed (e.g., with the the improvement plan) to the user based on a data maintained in an access module(e.g., the access module 230 of FIG. 2). At operation 850, the history data is updated based on a success flag (e.g., based on a performance threshold) associated with a quiz data in the access module. Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium).

For example, the integration module 102, the improvement list module 210, the profile module 220, the guardian module 222, the student module 224, the tutor module 226, the access module 230, the match module 232, the quiz module 234, the analysis module 240, the feedback module 250, the RSS module 260, the dashboard module 270, and the consortia generator module 280 may be enabled using an integration circuit, an improvement list circuit, a profile circuit, a guardian circuit, a student circuit, a tutor circuit, an access circuit, a match circuit, a quiz module circuit, an analysis circuit, a feedback circuit, an RSS circuit, a dashboard circuit and/or a consortia generator circuit using transistors, logic gates, and electrical circuits (e.g., application specific integrated ASIC circuitry) using a server circuit, a client circuit, a content circuit, a data analyzer circuit, a rules circuit, a configurator circuit, a simultaneous display circuit, a configuration requester circuit, a relationship circuit, a nesting generator circuit, a configurator circuit, a reverse configurator circuit, a identification generator circuit, and/or a model generator circuit.

In addition, it will be appreciated that the various operations, processes, and methods disclosed herein may be embodied in a machine-readable medium and/or a machine accessible medium compatible with a data processing system (e.g., a computer system), and may be performed in any order. The modules in the figures are shown as distinct and communicating with only a few specific module and not others. The modules may be merged with each other, may perform overlapping functions, and may communicate with other modules not shown to be connected in the Figures. Accordingly, the specification and drawings are to be regarded in an illustrative rather than a restrictive sense.

What is claimed is:

1. A method, comprising:
allocating an improvement plan to a user context based on a descriptive information of the user context;
integrating a history data of an item in the improvement plan to the improvement plan; and
simultaneously displaying the history data of the item in the improvement plan and the improvement plan to the user based on the data maintained in the access module.

2. The method of claim 1 wherein the history data corresponds to a previous association between the user and the item.

3. The method of claim 2 wherein the previous association is based on a check-out data, a page view data, a purchase data, a hold data, a quiz data, and a manual submission data.

4. The method of claim 1 further comprising generating the improvement plan based on a performance of the user on a standardized test.

5. The method of claim 4 wherein the improvement plan is printed on a report card of performance by the user on the standardized test.

6. The method of claim 4 wherein the standardized test determines which items are displayed in the improvement plan, and wherein the improvement plan is recommended by a government agency to the user.

7. The method of claim 6 wherein the standardized test is administered annually, and wherein the improvement plan includes between thirty and one hundred twenty individual items.

8. The method of claim 6 wherein the improvement list is periodically updated through a Really Simple Syndication (RSS) feed from the government agency.

9. The method of claim 1 further comprising updating the history data based on a success flag associated with a quiz data in the access module.

10. The method of claim 1 wherein the descriptive information of the user context is provided by the user, and wherein the descriptive information includes one or more of an age data, a grade data, a performance data, a calendar data, and an aptitude data.

11. The method of claim 1 the access module is shared in a consortium of individual member organizations.

12. The method of claim 1 wherein the displaying the history data of the item and an availability data of the item is rendered in a dashboard view comprising a previously accessed status indicator, a never accessed status indicator, and a percentage accessed indicator.

13. The method of claim 12 wherein the availability data includes a physical shelf location of the item at an access site.

14. The method of claim 1 in a form of a machine-readable medium embodying a set of instructions that, when executed by a machine, causes the machine to perform the method of claim 1.

15. A system, comprising:
a student module to allocate an improvement plan to a user context based a descriptive information of the user context; and
a guardian module associated with the student module to administer a quiz data of the improvement plan to at least one student associated with a guardian.

16. The system of claim 15 wherein the student module to simultaneously display a history data of an item in the improvement plan to the at least one student and the guardian based on a data maintained in an access module, wherein the history data corresponds to a previous association between the student and the item based on a check-out data, a purchase data, a hold data, a quiz data, and a manual submission data.

17. The system of claim 15 wherein a government reporting module to analyze the quiz data of the at least one student with other quiz data associated with different users to annually optimize the improvement plan.

18. The system of claim 15 wherein the guardian module to recommend online tutoring services for the at least one student based on a performance threshold in the quiz data.

19. A network, comprising:
a testing server to generate a recommended reading data based on a performance by a student in a standardized test; and
an integration server to automatically merge the recommended reading data with a library access data associated with the student.

20. The network of claim 19 wherein the recommended reading data is periodically updated through a Really Simple Syndication (RSS) feed from a government agency, and wherein the integration server to automatically apply an availability data of at least one library to the recommended reading list by associating the availability data with at least some items of the recommended reading list.
